(19) United States
(12) Patent Application Publication
(10) Pub. No.: US 2006/0077785 A1
(43) Pub. Date: Apr. 13, 2006

(54) Objective lens carrier structure for optical pickup head

(75) Inventor: Pei-Ching Kuo, Hsinchu City (TW)

Correspondence Address: BRUCE H. TROXELL, SUITE 1404, 5205 LEESBURG PIKE, FALLS CHURCH, VA, 22041, US

(73) Assignee: LITE-ON IT CORPORATION

(21) Appl. No.: 11/271,784

(22) Filed: Nov. 14, 2005

(30) Foreign Application Priority Data
Oct. 12, 2004 (TW) 93138415

(51) Int. Cl. G11B 7/00

(52) U.S. Cl. 369/44.14; 369/44.23; 369/44.15

(57) ABSTRACT

A lens-carrier structure, which is disposed between at least two magnetic generators of an optical pickup head, comprises an objective lens, a plate and a focusing coil. The plate comprises a top-face and a hole. The objective lens is disposed on the top-face and at a predetermined position corresponding to the hole. The focusing coil is printed on the plate. While conducting electric current to the focusing coil, the lens-carrier structure is moved along a vertical direction by a magnetic force generated from the magnetic field generators and the focusing coil

### BACKGROUND OF THE INVENTION

(1) Field of the Invention

The present invention generally relates to a field associated with optical pickup heads in optical reproducing machines, such as DVD player or recorder, and particularly to a lens-carrier structure of the optical pickup head for carrying an objective lens.

(2) Description of the Prior Art

Optical media, such as CD-ROM, DVD-ROM, DVD-RW, DVD+RW . . . etc., are very popular these days. These optical media are for recording digital information and are applied in personal computer (PC), notebook computer, Video player machine, audio system, and many other electronic products. In these electronic products, an optical pickup head is therefore needed for reading or recording information on an optical disc. An optical pickup head, which is related with the present invention, is an essential element of the optical reproducing machine.

Please refer to FIG. 1. It shows a typical optical pickup head 2. The optical pickup head 2 is movable within an optical reproducing machine to read different data at different locations on the optical disc. The optical pickup head 2 comprises a lens-carrier structure 4 and two magnetic field generators 6. The lens-carrier structure 4 is disposed between the magnetic field generators 6. The lens-carrier structure 4 comprises a holder 402 and an objective lens 404. The holder 402 has a tQp-face for containing the objective lens 404 and a plurality of side-faces.

The optical pickup head 2 further comprises a plurality of elastic arm 8 for supporting the lens-carrier structure 4. Through the elastic property of the elastic arm 8, the lens-carrier structure 4 is able to be moved slightly in the optical pickup head 2, not only located at a fixed position.

In order to slightly move the lens-carrier structure 4, the holder 402 is wound by wires to from some coils for acting with the magnetic field generators 6. In the traditional art, a focusing coil 10 winds around the side-faces of the holder 402. Tracking coils 12 are disposed on two opposite side-faces, which are near the respective magnetic field generator 6. As the prior lens-carrier structure 4 shown in FIG. 1, there are two tracking coils 12 disposed on one side-face, and there are four tracking coils 12 within the lens-carrier structure 4. The focusing coil 10 and the tracking coils 12 are usually enameled wires. Therefore, while electric current is directed through the focusing coil 10 or the tracking coils 12, a magnetic force generated from the magnetic field generators 6 and the coils (10 or 12) moves the lens-carrier structure 4.

As shown in FIG. 1. While the electric current is conducted through the focusing coil 10, the lens-carrier structure 4 is moved along a vertical direction (D1) so as to be applied in a focus servomechanism of the optical pickup head 2. In other hand, while the electric current is conducted through the tracking coils 12, the lens-carrier structure 4 is moved along a horizontal direction (D2) so as to be applied in a track servomechanism of the optical pickup head 2.

However, a major tendency of designing electronic products is size-reducing. A small form factor optical disk drive (SFFO) is a size-reduced optical reproducing machine for example. In this art, there needs some spaces on the holder 402 for winding the wires, therefore the size the holder 402 is difficult to be reduced, which becomes an undesired unit in the optical pickup head 2. It seems to be a choke point for the space arrangement of the optical pickup head 2.

Besides, while coiling the enameled wires to form the focusing coil 10 or the tracking coils 12, specific machines and procedures are needed. Under the size-reducing concern, these specific procedures for coiling the enameled wires are hard to maintain required qualities. Extra costs and manufacturing hours are generated therefore.

### SUMMARY OF THE INVENTION

One objective of the present invention is to provide a size-reduced lens-carrier structure for an optical pickup head.

Another objective of the present invention is to provide a size-reduced lens-carrier structure, which is able to be manufactured during a shortened hours.

Another objective of the present invention is to provide a size-reduced lens-carrier structure, which costs less.

A lens-carrier structure, which is disposed between at least two magnetic generators of an optical pickup head, is provided. The lens-carrier structure comprises an objective lens, a plate, a focusing coil, at least one tracking coil and a plurality of elastic arms. The plate comprises a top-face and a hole. The objective lens is disposed on the top-face and at a predetermined position corresponding to the hole. The focusing coil is printed on the plate. In one embodiment, the focusing coil is printed on the top-face of the plate. In other embodiment, the plate is a multi-layer structure, and the focusing coil is printed on one or a plurality of the inner layer of the plate. The at least one tracking coil is disposed on the top-face of the plate in one embodiment. In other embodiment, the at least one tracking coil is disposed on the side-face of the plate. While conducting with electric current, the lens-carrier structure is moved along a vertical direction by a magnetic force generated from the magnetic field generators and the focusing coil, or, the lens-carrier structure is moved along a horizontal direction by a magnetic force generated from the magnetic field generators and the tracking coil.

The advantage and spirit of the invention may be understood by the following recitations together with the appended drawings.

### BRIEF DESCRIPTION OF THE DRAWINGS

The present invention will now be specified with reference to its preferred embodiment illustrated in the drawings, in which:

FIG. 1 shows a typical optical pickup head.

FIG. 2 shows a top view of the present lens-carrier structure.

FIG. 3 shows an optical pickup head relating to the present invention.

FIG. 4 is a cross-section view of the lens-carrier structure of FIG. 2 along the 4-4 cross section line.

FIG. 5 shows a top view of another embodiment of the present lens-carrier structure.

FIG. 6 is a cross-section view of the lens-carrier structure of FIG. 2 along the 6-6 cross section line.

### DESCRIPTION OF THE PREFERRED EMBODIMENT

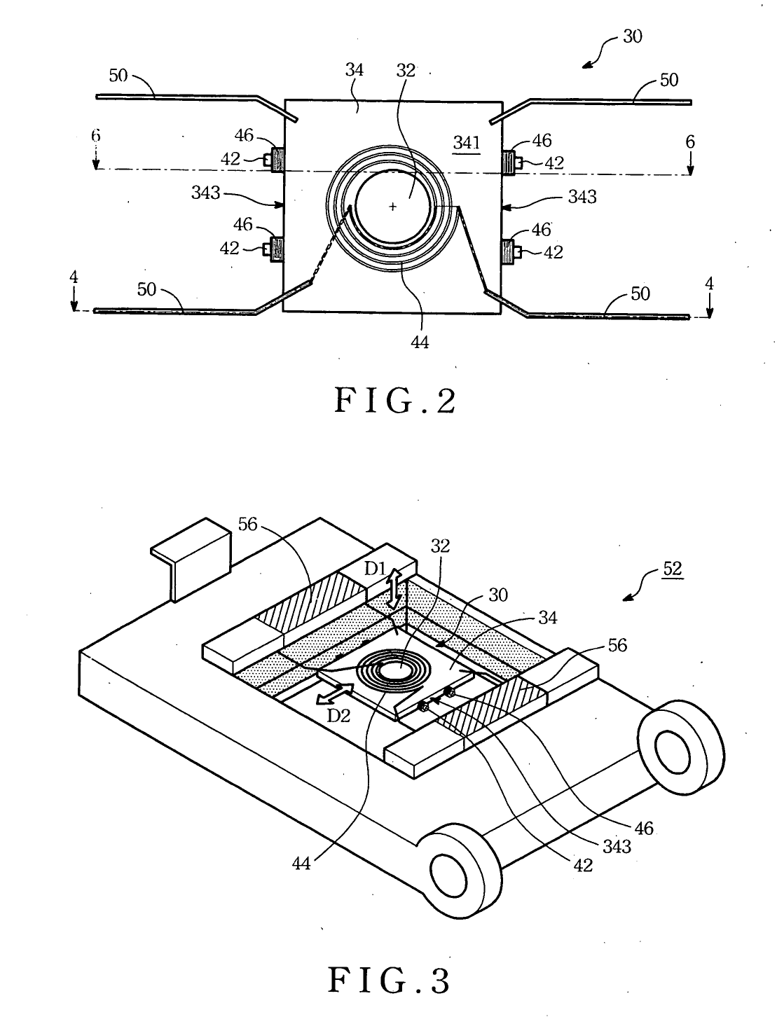

Please refer to FIG. 2. FIG. 2 shows a top view of the present lens-carrier structure. The lens-carrier structure 30 is disposed in an optical pickup head 52 (please refer to FIG. 3) for carrying an objective lens 32. The optical pickup head 52 is movable within an optical reproducing machine to read different data at different locations on an optical disc. The optical pickup head 52 also comprises two magnetic field generators 56. The lens-carrier structure 30 is disposed between the magnetic field generators 56.

The lens-carrier structure 30 comprises a plate 34, an objective lens 32, a focusing coil 44 and at least one elastic arm 50. The plate 34 has a top-face 341, which supports the objective lens 32 and contains a plurality of side-faces 343. In one embodiment of the present invention, the focusing coil 44 is disposed on the top-face 341. In other embodiments, the plate 34 is a multi-layer structure, such as printed circuit board (PCB), so the focusing coil 44 can be disposed within the plate 34 on one or several inner layers. The focusing coil 44 is one or a plurality of metal pattern layer formed by a photo-etching process in these PCB embodiments. As the embodiment according to FIG. 2, the focusing coil 44 is a spiral-shaped metal pattern layer.

In some embodiments, there is at least one bumping 42 disposed on one of the two opposite side-faces, which are near the magnetic field generator 56. As the embodiment according to FIG. 2, the two opposite side-faces totally comprise four bumpings 42, two bumpings for each. The lens-carrier structure further comprises a plurality of tracking coils 46, which wind around the bumpings 42 respectively. While the electric current is conducted through the focusing coil 44, the lens-carrier structure 30 is moved along a vertical direction (D1) so as to be applied in a focus servomechanism of the optical reproducing machine. In other hand, while the electric current is conducted through the tracking coils 46, the lens-carrier structure 30 is moved along a horizontal direction (D2) so as to be applied in a track servomechanism of the optical reproducing machine.

Each of the elastic arms 50 shown in FIG. 2 is for supporting the plate 34. Through the elastic property of the elastic arm 50, the lens-carrier structure 30 is able to be moved slightly in the optical pickup head 52, not only located at a fixed position. Therefore, while electric current is directed through the focusing coil 44 or the tracking coils 46, a magnetic force generated from the magnetic field generators 56 and the coils (44 or 46) moves the lens-carrier structure 30. Considering to the rectangular-shaped plate 34, symmetrically disposing four elastic arms 50 within the lens-carrier structure 30 is a preferred embodiment. As shown in FIG. 2, four elastic arms 50 are disposed symmetrically on the top-face 341 to fix with the plate 34.

In some embodiments, conductive material is selected for the elastic arms 50. Therefore, the elastic arms 50, which are electrically connected with the focusing coil 44 or the tracking coils 46, are not only for elastically supporting the plate, but for providing electric current to the focusing coil 44 or the tracking coils 46.

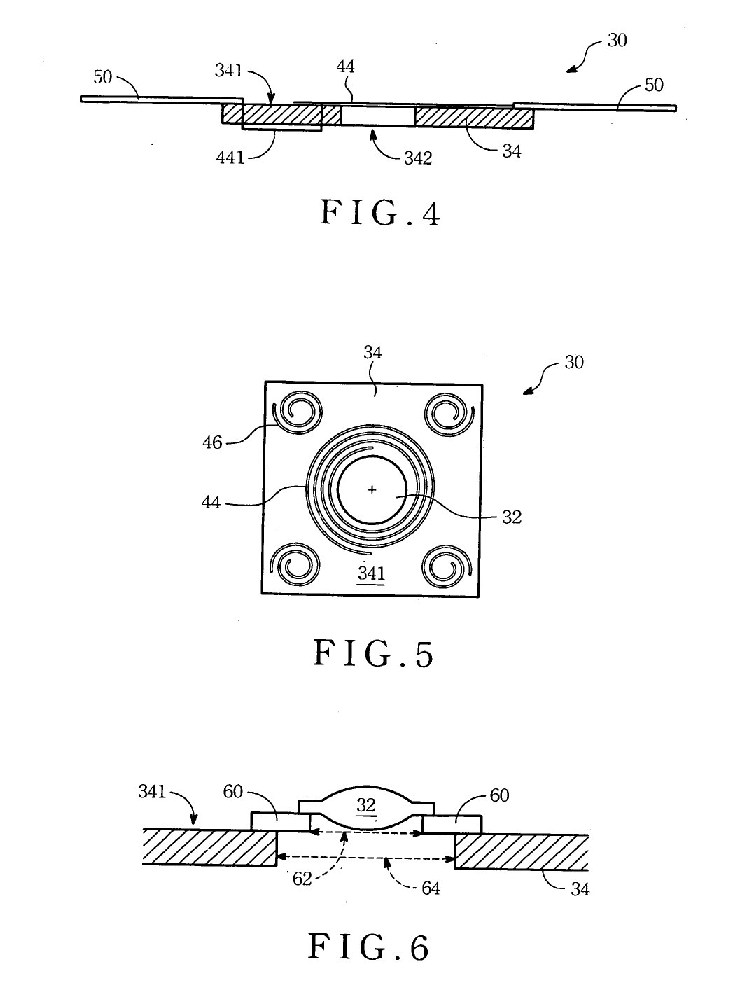

Please refer to FIG. 4. It is a cross-section view of the lens-carrier structure of FIG. 2 (along the 4-4 cross section line). In this embodiment, one end of the focusing coil 44 connects to a elastic arm 50 on the top-face 341. The other end of the focusing coils 44 connects to a elongating wire 441, which is disposed on a bottom-face 342 of the plate 34, through a through hole of the plate 34. Moreover, the elongating wire 441 connects to another elastic arm 50, which is disposed on the top-face 341, through another through hole.

Please refer to FIG. 5, it shows a top view of another embodiment of the present lens-carrier structure. The plate 34 of the lens-carrier structure 30 according to FIG. 5 has a top-face 341, which supports the objective lens 32. Besides the focusing coil 44, the tracking coils 46 are also disposed on the top-face 341. In this embodiment, the focusing coil 44 and the tracking coils 46 are printed on the top-face 341. Accompanied with the magnetic field generator 56, the focusing coil 44 is disposed to move the lens-carrier structure 30 along the vertical direction (D1); and the tracking coils 46 are disposed to move the lens-carrier structure 30 along the horizontal direction (D2). While operating, the electric current can be directed to the focusing coil 44 or the tracking coils 46 through the elastic arms 50 shown in FIG. 4.

Please refer to FIG. 6. FIG. 6 is another cross-section view of the lens-carrier structure of FIG. 2 (along the 6-6 cross section line). The lens-carrier-structure 30 further comprises an adapter 60. The adapter 60 is disposed on the top-face 341 to cover a hole 64 of the plate 34. The hole 64 has a first diameter. The adapter 60 has an entrance pupil 62, which has a second diameter smaller than the first diameter of the hole 64, for limiting the entrance light amount. The objective lens 32 has a third diameter, which is bigger than the second diameter. So the objective lens 32 is able to be disposed on the adapter 60 to cover the entrance pupil 62.

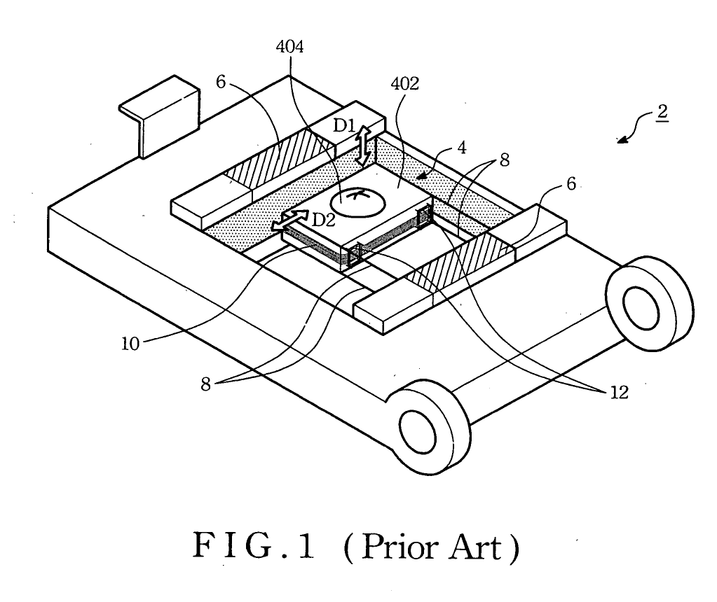

Accordingly, the present lens-carrier structure utilizes a plate, such as PCB, to replace the traditional large-sized holder (FIG. 1, numeral 402) for carrying the objective lens in the optical pickup head. The coils can be printed on the face of the plate without a coiling space, and a size-reduced lens-carrier structure is thus provided. By applying the present lens-carrier structure, the size-reducing tendency of designing electronic products can be satisfied. In the other hand, the present focusing coil or tracking coil can be manufactured by the photo-etching process to print on (or within) a plate. The manufacturing hours generated from coiling enameled wires of prior arts thus can be saved. Extra costs caused from specific machines for coiling enameled wires are also no more needed.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

I claim:

1. A lens-carrier structure, which is disposed between at least two magnetic generators of an optical pickup head, comprising:
an objective lens; and
a plate, comprising a top-face and a hole, wherein the objective lens is disposed on the top-face and at a predetermined position corresponding to the hole; and
a focusing coil, printed on the plate,
whereby the lens-carrier structure is moved along a vertical direction by a magnetic force generated from the magnetic field generators and the focusing coil.

2. The lens-carrier structure according to claim 1, wherein the plate is a printed circuit board (PCB).

3. The lens-carrier structure according to claim 1, wherein the focusing coil is printed on the top-face of the plate.

4. The lens-carrier structure according to claim 1, wherein the focusing coil is a spiral-shaped metal pattern layer.

5. The lens-carrier structure according to claim 3 further comprising an elongating wire, which is disposed on a bottom-face of the plate opposite to the top-face, wherein one end of the focusing coil elongates on the top-face, and the other end of the focusing coil connects to the elongating wire through a through hole of the plate.

6. The lens-carrier structure according to claim 1 further comprising at least one tracking coil disposed on the top-face of the plate, whereby the lens-carrier structure is moved along a horizontal direction by a magnetic force generated from the magnetic field generators and the tracking coil.

7. The lens-carrier structure according to claim 1 further comprising:
at least one bumping, disposed on one side-face of the plate; and
at least one tracking coil, disposed on the bumping,
whereby the lens-carrier structure is moved along a horizontal direction by a magnetic force generated from the magnetic field generators and the tracking coil.

8. The lens-carrier structure according to claim 1 further comprising a plurality of elastic arms for supporting the plate in the optical pickup head.

9. The lens-carrier structure according to claim 8, wherein the total amount of the plurality of elastic arms is four, wherein the four elastic arms are symmetrically disposed within the lens-carrier structure.

10. The lens-carrier structure according to claim 8, wherein a conductive material is selected for said elastic arm, which is electrically connected with the focusing coil, for providing electric current to the focusing coil.

11. The lens-carrier structure according to claim 1, wherein the lens-carrier structure further comprising an adapter disposed on the top-face of the plate to cover the hole, the adapter having a entrance pupil smaller than the hole, the objective lens disposed on the adapter to cover the entrance pupil.

12. A lens-carrier structure, which is disposed between at least two magnetic generators of an optical pickup head, comprising:
an objective lens; and
a plate, comprising a top-face and a hole, wherein the objective lens is disposed on the top-face and at a predetermined position corresponding to the hole;
a focusing coil, printed on the plate; and
at least one tracking coil, disposed on the top-face of the plate;
whereby the lens-carrier structure is moved along a vertical direction by a magnetic force generated from the magnetic field generators and the focusing coil,
whereby the lens-carrier structure is moved along a horizontal direction by a magnetic force generated from the magnetic field generators and the tracking coil.

13. The lens-carrier structure according to claim 12, wherein the plate is a printed circuit board (PCB).

14. The lens-carrier structure according to claim 12, wherein the focusing coil is printed on the top-face of the plate.

15. The lens-carrier structure according to claim 12, wherein the focusing coil is a spiral-shaped metal pattern layer.

16. The lens-carrier structure according to claim 14 further comprising an elongating wire, which is disposed on a bottom-face of the plate opposite to the top-face, wherein one end of the focusing coil elongates on the top-face, and the other end of the focusing coil connects to the elongating wire through a through hole of the plate.

17. The lens-carrier structure according to claim 12 further comprising a plurality of elastic arms for supporting the plate in the optical pickup head.

18. The lens-carrier structure according to claim 17, wherein the total amount of the plurality of elastic arms is four, wherein the four elastic arms are symmetrically disposed within the lens-carrier structure.

19. The lens-carrier structure according to claim 17, wherein a conductive material is selected for said elastic arm, which is electrically connected with the focusing coil, for providing electric current to the focusing coil.

20. The lens-carrier structure according to claim 12, wherein the lens-carrier structure further comprising an adapter disposed on the top-face of the plate to cover the hole, the adapter having a entrance pupil smaller than the hole, the objective lens disposed on the adapter to cover the entrance pupil.
